(19) United States
(12) Patent Application Publication
(10) Pub. No.: US 2010/0161407 A1
(43) Pub. Date: Jun. 24, 2010

(54) Method and apparatus for presenting credit card offers

(76) Inventors: William Joseph Farmer, Austin, TX (US); John Durrett, Austin, TX (US); Jeff Whitmire, Austin, TX (US)

Correspondence Address: COOPER & DUNHAM, LLP, 30 Rockefeller Plaza, 20th Floor, NEW YORK, NY, 10112, US

(21) Appl. No.: 12/317,583

(22) Filed: Dec. 24, 2008

(51) Int. Cl. G06Q 30/00; G06Q 10/00; G06Q 40/00

(52) U.S. Cl. 705/14.43; 705/14.45; 705/14.66; 705/14.73

(57) ABSTRACT

Method and apparatus for presenting credit card offers over the internet. The method includes assigning a weight to each of a plurality of categories of offer elements, each of the plurality of categories of offer elements including a plurality of offer elements, assigning a weight to each offer element in each of the plurality of categories of offer elements, providing a plurality of credit card offers, evaluating each of the plurality of credit card offers to determine whether the credit card offer has at least one offer element corresponding to at least one of the plurality of offer elements, determining an overall weight based on the weights assigned to the offer elements corresponding to the at least one of the plurality of offer elements and based on the overall weights of each of the credit card offers, determining where on a webpage to display each of the credit card offers.

### BACKGROUND

1. Technical Field

The present disclosure relates generally to the presentation of offers and, more particularly, to a method and apparatus for presenting credit card offers.

2. Description of the Background Art

There are numerous websites on the Internet that present credit card offers from various institutions. These sites generally provide detailed information on each offer and allow users to view the detailed offer information and to select those cards they may be interested in applying for. Some sites provide hyperlinks to allow users to easily navigate to websites associated with selected credit card offers so that the users can easily apply for the cards.

In the field of ecommerce, affiliate marketing or “pay for performance” or “cost per action” have been long standing practices. Arrangements are made between website publishers and advertisers where the website publishers use banner advertisements, text links, etc. to refer visitors to the advertisers' websites. The advertiser generally pays the publishers when a referred visitor takes some agreed upon action, such as filling out a lead form (e.g., an application) or completing a purchase, etc.

Often, the amount the advertiser pays the publisher is a negotiated “per activity” price. The amount and activity agreed upon can vary greatly, depending on the subject matter being advertised, etc. In the field of credit cards, affiliate marketing relationships are commonly based on either completed applications or opened accounts, etc. In these cases, the advertiser will pay the publisher a set amount for each application completed by a referred visitor and/or for each account opened by a referred visitor. For example, the advertiser and publisher may agree to a rate of $100 per approved account. That is, if a user referred to the issuer by the publisher opens a new account, the issuer will pay the publisher $100. Often, issuers and publishers negotiate attainment bonuses. This is a common practice where advertisers offer publishers incentives for supplying a set level of referrals. For example, advertisers may establish volume tiers as shown in FIG. 1. If a publisher refers 1-1,000 users to the advertiser's credit card application website that get approved for the credit card, the rate paid to the publisher is $110/per account. More than 1,000 approvals the publisher gets $115/per account, etc. These bonuses can change the economic value of the negotiated “per activity” price and are often tracked by the Director of Sales and the Director of Business Analytics. Time certain is the period for which the negotiated fee is in effect or the period for which the attainment bonuses are available. In the above-example, the time certain is the period of Jan. 1-31, 2008.

Of course, it will be appreciated that different issuers may provide different incentives. It is important for publishing websites to get the most out of each referred visitor. Publisher websites often display or present offers to users based on the negotiated “per activity” price. That is, each credit card offer is assigned a relative position within a set of offers. For example, the higher the negotiated “per activity” price, the more prominently (sooner, specific location on the web page, etc.) the associated product will be displayed. However, there are also other offer elements that can be used to assign a relative position to a credit card offer.

### SUMMARY

This application describes tools (in the form of methodologies, apparatuses, and systems) for presenting credit card offers. The tools may be embodied in one or more computer programs stored on a computer readable medium or program storage device and/or transmitted in the form of a computer data signal in one or more segments via a computer network or other transmission medium.

Method and apparatus for presenting credit card offers over the internet. The method includes assigning a weight to each of a plurality of categories of offer elements, each of the plurality of categories of offer elements including a plurality of offer elements, assigning a weight to each offer element in each of the plurality of categories of offer elements, providing a plurality of credit card offers, evaluating each of the plurality of credit card offers to determine whether the credit card offer has at least one offer element corresponding to at least one of the plurality of offer elements, determining an overall weight based on the weights assigned to the offer elements corresponding to the at least one of the plurality of offer elements and based on the overall weights of each of the credit card offers, determining where on a webpage to display each of the credit card offers.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an example of volume tiers that may be established by advertisers;

FIG. 2 shows a block diagram of a computer system capable of implementing aspects of embodiments of the present disclosure;

FIG. 3 is a block diagram showing a website system according to an embodiment of the present disclosure;

FIG. 4 is a flow chart for describing a method according to an embodiment of the present disclosure;

FIG. 5 is a chart showing weights assigned to various categories and elements according to an embodiment of the present disclosure; and

FIG. 6 shows examples of credit card elements for describing various aspects of embodiments of the present disclosure.

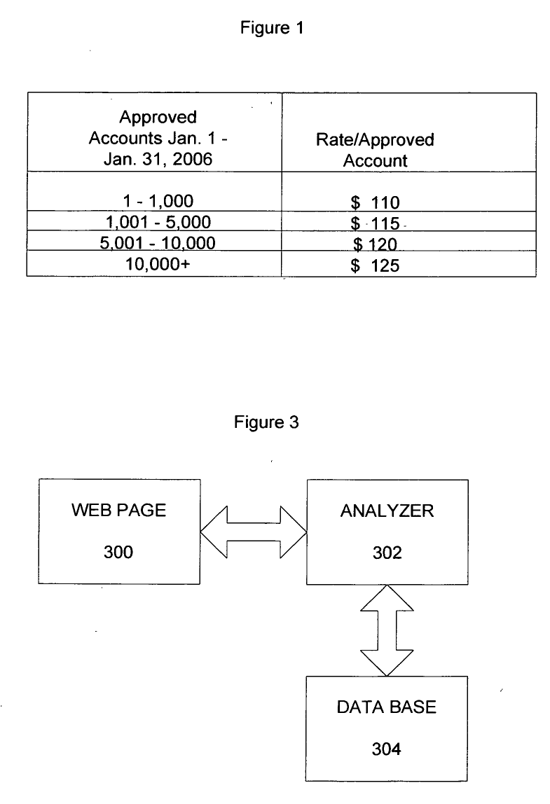

### DETAILED DESCRIPTION

The following exemplary embodiments are set forth to aid in an understanding of the subject matter of this disclosure, but are not intended, and may not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner.

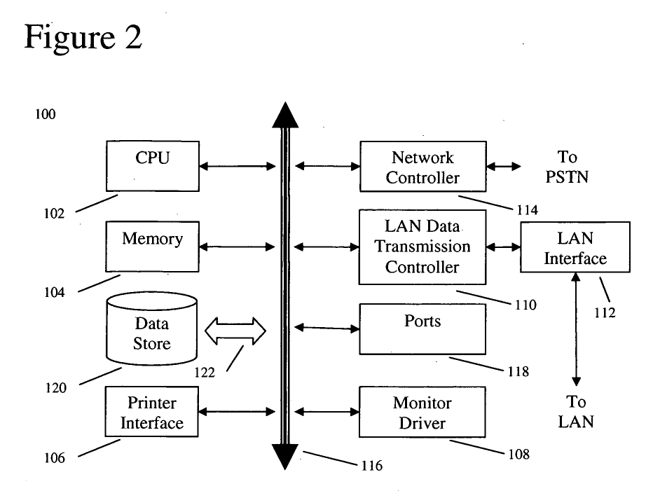

FIG. 2 shows an example of a computer system 100 which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system, for example, floppy disk, compact disk, hard disk, etc., or may be remote from the computer system and accessible via a hard wired or wireless connection to a network, for example, a local area network, or the Internet.

The computer system 100 can include a central processing unit (CPU) 102, program and data storage devices 104, a printer interface 106, a display unit 108, a (LAN) local area network data transmission controller 110, a LAN interface 112, a network controller 114, an internal bus 116, and one or more input devices 118 (for example, a keyboard, mouse etc.). As shown, the system 100 may be connected to a database 120, via a link 122.

The computer system 100 is merely exemplary. The specific embodiments described herein are illustrative, computer system(s) as referred to herein may include(s) individual computers, servers, computing resources, networks, etc., and many variations can be introduced on these embodiments without departing from the spirit of the disclosure or from the scope of the appended claims.

Embodiments of the present disclosure relate to a system for assigning a numerical weighting to each element of a credit card offer, for the purpose of assigning its relative position within a set of offers. The system can be applied to any card offer within a collection of card offers. The term “offer” is used herein, includes any way of presenting information relating to the credit card including, for example, advertisements, etc.

According to an embodiment of the present disclosure as shown in FIG. 3, credit card offers are displayed on a web page 300. Offers are strategically presented or displayed on the web page 300 so that offers likely providing more revenue to the website provider are displayed to receive the most “hits” by users of the website. Analyzer 302 analyzes categories of information relating to credit card offers which information is stored in database 304. Analyzer 302 may include one or more computer systems capable of parsing information, analyzing the information and making decisions based on the analysis. For example, the information can be analyzed and weights can be assigned to the information as will be described in more detail later below. Analyzer 302 may also include input from one or more human analysts. Analyzer 302 assigns a numerical weight to one or more elements in broad categories of offer elements. The numerical weight assigned to any given element (E) may be called the CardRank of E and may be denoted herein CR(E). Based on the overall assigned weight for each credit card offer, analyzer 302 strategically arranges the offers on web page 300.

According to an embodiment of the present disclosure, four broad categories of credit card offer elements are analyzed. These categories include “Economic Value,” “User Preference,” “User Completion Rates” and “Issuer Practices.” Each category may include one or more elements upon which a category is based. For example, “Economic Value” may be based on one or more elements including, for example, negotiated “per activity” price, negotiated attainment bonuses, non-per activity fees and time certain.

The category “Economic Value” refers to the economic value to the publisher for completion of a specified activity for an offer, within a time certain. Weights can be assigned to each category, depending on the perceived benefit to the publisher. Each category can be assigned the same weight or one or more categories may be assigned different weights. For example, the category “Economic Value” directly affects the bottom line of the publisher. Accordingly, “Economic Value” may be assigned a relatively high weight compared to, for example, “Issuer Preferences”. In addition, each element in a category can be assigned the same weight or one or more of the elements can be assigned different weights. For example, “per activity” price directly affects the bottom line of the publisher. Accordingly, “per activity” price can be heavily weighted overall. In addition, higher negotiated “per activity” prices may be more heavily weighted compared to lower “per activity” prices. Negotiated attainment bonuses may also be more heavily weighted overall, since this also can directly affect the bottom line of the publisher. Non-per activity fees can include fees paid to the publisher even when users do nothing more than visit the issuer's website after getting redirected there from the publisher's site. Generally, the rates paid for non-per activity fees are considerably less than “per activity” fees and will thus likely have a lower weight assigned.

The second category is “User Preference” for an offer. An estimate of user preference can be based on historical data including, for example, historical offer user selection rates, relative offer position influence on user preference, categorization and context of the offer and appeal of offer terms, relative to other offers in the set. Historical uses of various aspects of the publisher's website can be maintained and analyzed and used according to embodiments of the present disclosure. For example, historical offer user selection rates can be used to determine which type of credit card users generally prefer. For example, if it is determined that users generally prefer a VISA card over a MASTERCARD, this can be taken into account when a weight is assigned. Relative offer position relates to the position on the web page where the offer is to be presented and can have an influence on user preference. For example, offers presented in the middle of a web page may actually get greater user response than offers placed at other positions of the web page since the middle of the web page is generally directly at eye level and is usually the first thing a user sees when visiting a site. Offer terms of various products can be categorized and put into relative context and the appeal of those offer terms can be weighted to contribute to aspects of the present disclosure.

The third category is “User Completion Rate” of a specified activity. An estimate of the user completion rate can be based on, for example, historical completion rates and subjective adjustments for impacts of known changes in user experience. Some credit cards request more and/or different information on their application forms, which can affect how likely a user is to fill the application out. Even layout of the application form can have an affect on which application form users are more likely to fill out. This information can be gathered from the historical information and used by embodiments of the present disclosure.

The fourth category is “Issuer Practices.” An estimate of issuer practices can be based on, for example, historical approval rates and subjective adjustments for impacts of known changes in issuer practices. Credit card issuers that historically have higher approval rates would generally be assigned more weight than those have lower approval rates, particularly if there is a per-activity rate associated with the card and requires the user to be approved prior to the referring website getting credited with a fee.

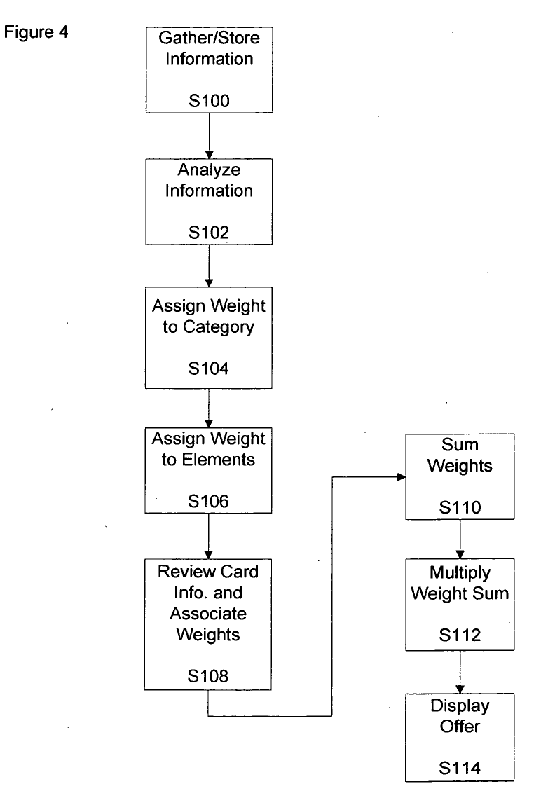

According to an embodiment of the present disclosure as shown in FIG. 4, information is saved and/or gathered in a database (Step S100). The information may include the categories and elements of information as described above. Of course, other types of information may also be stored as desired. The information can be parsed and analyzed. For example, according to an embodiment of the present disclosure, an information analyzer reviews the categories of information (Step S102) including Economic Value, User Preference, User Completion Rate and Issuer Practices and assigns a weight to each category (Step S104). The analyzer then assigns weights to each element in each category being used (Step S106). The credit card information is then reviewed to determine which elements apply to each card and to determine the associated weight of each element (Step S108). The element weights associated with a card are then summed for each category (Step S110). The sum in each category is then multiplied by the category's weight to determine the overall value of the card (Step S112). The card offers are then displayed or presented on the site based on their overall value (Step S114).

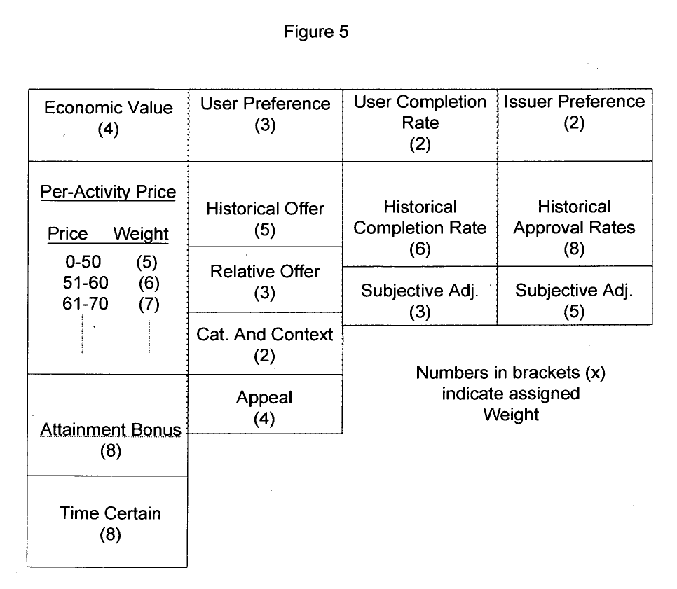

An example of the values applied to each category and element is shown by chart in FIG. 5. In this example, Economic Value is assigned a numerical weight of 4, User Preference is assigned a weight of 3, User Completion Rate is assigned a weight of 2 and Issuer Preferences is also assigned a weight of 2. Each element in each category can be assigned a flat weight depending on whether the element is present or the weight can vary depending on a variable. For example, “per activity” price can be assigned a weight of 10 regardless of how much the price is. In the alternative, as shown in FIG. 5 and in the following examples, “per activity” price can be assigned a weight depending on the price negotiated.

As shown, “per activity” price is assigned a weight depending on the price. In this example, any per activity price $50 and below is assigned a weight of 5. For each increment of $10 above $50, the assigned weight is increased by 1. For example, a per activity price between $51-$60 is assigned a weight of 6, a per activity price between $61-$70 is assigned a weight of 7, etc. “Attainment bonuses and non-per activity fees” can be assigned a weight depending on the amount of the bonus and/or when/how the bonuses kick in. However, according to this example, “attainment bonuses” are assigned a flat weight of 8. For example, and time certain is assigned a weight of 8. In the “User Preference” category, “historical offer user selection rates” is assigned a weight of 5, “relative offer position influence on user preference” is assigned a weight of 3, “categorization and context of the offer” is assigned a weight of 2 and “appeal of offer terms” is assigned a weight of 4. In the “User Completion Rate” category, historical completion rate is assigned a weight of 6, subjective adjustment is assigned a weight of 3. In the “Issuer Practices” category, historical approval rates are assigned a weight of 8 and subjective adjustments a weight of 5. However, the historical approval rate of this card is high and the card has high historical user preference.

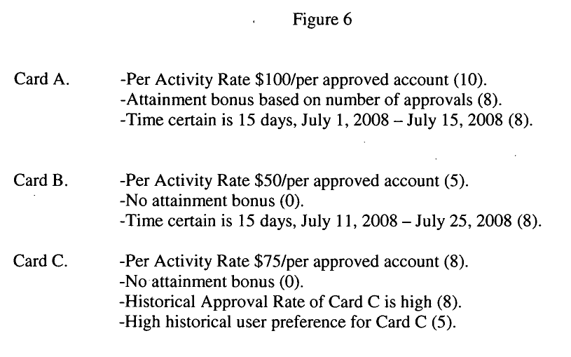

An example of a number of credit card offers is shown in FIG. 6. Card “A” has a per activity rate of $100/per approved account and includes attainment bonuses based on number of approvals as shown. The time certain is a 15 day period from Jul. 1, 2008-Jul. 15, 2008. Card “B” has a per activity rate of $50/per approved account and does not include any attainment bonuses. The time certain is a 15 day period from Jul. 11, 2008-Jul. 25, 2008. Card “C” has a per activity rate of $75/per approved account and does not include any attainment bonuses. The historical approval rate of card “C” is relatively high. This can be determined in any number of ways. For example, this can be determined by comparing the approval rate of card “C” to the approval rate of all known credit cards or, in the alternative, to only those cards presently being analyzed. Card “C” also has high historical user preference. User preference can be determined based on the number of “hits” the card receives on the website or based on the popularity of the particular type of card, bank, etc.

Utilizing the chart from FIG. 5, weights are assigned as shown in “weight” column 500. Now, multiplying each element by the category weight value, the overall weight can be determined. For example, Card A has a total element weight of 26. Multiplied by economic by economic value weight of 4, that gives Card A an overall value of 104. Using this same system for Card B and Card C, it is seen that Card B has an overall weight of 52 and Card C has an overall weight of 61.

Accordingly, when these credit card offers are presented on the website, they can be placed so that Card A offer will be placed at the “best” (e.g., first viewed) spot on the site, Card C will be placed on the next “best” spot on the site and Card B will be placed at the next “best” spot on the site. The ranking of the “most viewed spots” on the site may be determined based on historical selections on this site. Of course, the ranking of the “best” spot can be determined based on independent marketing studies used to determine rankings regarding which locations on a web site are more likely to be seen by visitors to the site, etc.

Embodiments of the present disclosure can be implemented in digital electronic circuitry, or in computer hardware, firmware, software, or in combinations of them. Embodiments can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps associated with embodiments of the present disclosure can be performed by one or more programmable processors executing a computer program to perform functions of the disclosure by operating on input data and generating output. Method steps can also be performed by, and apparatus of the present disclosure can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; CD-ROMs (Compact Disc Read-only Memory) and DVD-ROMs (Digital Versatile Disc Read-only Memory). The processor and the memory can be supplemented by, or incorporated in special purpose logic circuitry.

To provide for interaction with a user, embodiments of the present disclosure can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the present disclosure can be implemented in a computing system that includes a back-end component, e.g., as a data server, or that includes a middle-ware component, e.g., an application server, or that includes a front-end component, e.g., a client computer having a graphical interface or a Web browser through which a user can interact with an implementation of the invention, or any combination of such back-end, middleware, or front-end components. The components of the computing system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on respective computers and having a client-server relationship to each other.

Numerous additional modifications and variations of the present disclosure are possible in view of the above-teachings. It is therefore to be understood that within the scope of the appended claims, the present disclosure may be practiced other than as specifically described herein. For example, elements and/or features of different illustrative embodiments may be combined with each other and/or substituted for each other within the scope of this disclosure and appended claims.

What is claimed is:

1. A method for presenting credit card offers over the internet comprising:
assigning a weight to each of a plurality of categories of offer elements, each of the plurality of categories of offer elements including a plurality of offer elements;
assigning a weight to each offer element in each of the plurality of categories of offer elements;
providing a plurality of credit card offers;
evaluating each of the plurality of credit card offers to determine whether the credit card offer has at least one offer element corresponding to at least one of the plurality of offer elements;
determining an overall weight based on the weights assigned to the offer elements corresponding to the at least one of the plurality of offer elements; and
based on the overall weights of each of the credit card offers, determining where on a webpage to display each of the credit card offers.

2. The method of claim 1, wherein the plurality of categories comprise economic value, user preference, user completion rate and issuer preferences.

3. The method of claim 2, wherein the economic value category comprises elements of per-activity price, attainment bonuses and time certain.

4. The method of claim 2, wherein the category of user preference comprises elements of historical offer information, relative offer information, categorization and context of the offer and appeal of offer terms.

5. The method of claim 2, wherein the category of user completion rate comprises elements of historical completion rates by users and subjective adjustments.

6. The method of claim 2, wherein the category of issuer practices comprises elements of historical approval rates of issuer and subjective adjustments.

7. A computer data signal transmitted in one or more segments in a transmission medium which embodies instructions executable by a computer to perform the method of claim 1.

8. A computer system comprising:
a processor; and
a program storage device readable by the computer system, tangibly embodying a program of instructions executable by the processor to perform the method of claim 1.

9. An apparatus for evaluating and presenting credit card offers over the internet, comprising:
a category weight assigning system for assigning a weight to each of a plurality of categories of offer elements, each of the plurality of categories of offer elements including a plurality of offer elements;
an element weight assigning system for assigning a weight to each offer element in each of the plurality of categories of offer elements;
a system for providing a plurality of credit card offers;
an evaluating system for evaluating each of the plurality of credit card offers to determine whether the credit card offer has at least one offer element corresponding to at least one of the plurality of offer elements;
a determining system for determining an overall weight based on the weights assigned to the offer elements corresponding to the at least one of the plurality of offer elements; and
based on the overall weights of each of the credit card offers, determining where on a webpage to display each of the credit card offers.

10. The apparatus of claim 9, wherein the plurality of categories comprise economic value, user preference, user completion rate and issuer preferences.

11. The apparatus of claim 10, wherein the economic value category comprises elements of per-activity price, attainment bonuses and time certain.

12. The apparatus of claim 10, wherein the category of user preference comprises elements of historical offer information, relative offer information, categorization and context of the offer and appeal of offer terms.

13. The apparatus of claim 10, wherein the category of user completion rate comprises elements of historical completion rates by users and subjective adjustments.

14. The apparatus of claim 10, wherein the category of issuer practices comprises elements of historical approval rates of issuer and subjective adjustments.

15. A computer readable storage medium including computer executable code for presenting credit card offers over the internet, comprising:
code for assigning a weight to each of a plurality of categories of offer elements, each of the plurality of categories of offer elements including a plurality of offer elements;
code for assigning a weight to each offer element in each of the plurality of categories of offer elements;
code for providing a plurality of credit card offers;
code for evaluating each of the plurality of credit card offers to determine whether the credit card offer has at least one offer element corresponding to at least one of the plurality of offer elements;
code for determining an overall weight based on the weights assigned to the offer elements corresponding to the at least one of the plurality of offer elements; and
code for based on the overall weights of each of the credit card offers, determining where on a webpage to display each of the credit card offers.

16. The computer readable storage medium of claim 15 wherein the plurality of categories comprise economic value, user preference, user completion rate and issuer preferences.

17. The computer readable storage medium of claim 16, wherein the economic value category comprises elements of per-activity price, attainment bonuses and time certain.

18. The computer readable storage medium of claim 16, wherein the category of user preference comprises elements of historical offer information, relative offer information, categorization and context of the offer and appeal of offer terms.

19. The computer readable storage medium of claim 16, wherein the category of user completion rate comprises elements of historical completion rates by users and subjective adjustments.

20. The computer readable storage medium of claim 16, wherein the category of issuer practices comprises elements of historical approval rates of issuer and subjective adjustments.
